(19) United States
(12) Patent Application Publication
(10) Pub. No.: US 2013/0111428 A1
(43) Pub. Date: May 2, 2013

(54) GRAPHICAL USER INTERFACE FOR INTEGRATED DEVELOPMENT ENVIRONMENT TOOL

(71) Applicants: Andrew Brian Begel, Seattle, WA (US); Anja Guzzi, Delft (NL)

(72) Inventors: Andrew Brian Begel, Seattle, WA (US); Anja Guzzi, Delft (NL)

(73) Assignee: MICROSOFT CORPORATION, Redmond, WA (US)

(21) Appl. No.: 13/282,415

(22) Filed: Oct. 26, 2011

(51) Int. Cl. G06F 9/44

(52) U.S. Cl. 717/101

(57) ABSTRACT

Technologies pertaining to provision of relevant information to a developer of a software product are described herein. A graphical user interface of an integrated development environment tool includes a list of selectable files. Responsive to a user selecting a file, images that identify individuals that have previously modified the selected file are provided to the user. Responsive to the user selecting an image, additional detail pertaining to the individual identified by the image and her historic modification of the file is provided to the user.

### BACKGROUND

Software development, which is also referred to as application development, software design, designing software, software application development, enterprise application development, or platform development, is the development of a software product. Oftentimes a particular software product will require thousands, hundreds of thousands, or even millions of lines of code. Accordingly, for large scale software products, many different individuals who may belong to different teams and located in different geographic locations must collaborate to develop a software product successfully. It can thus be understood that successfully developing software products requires effective communication between dependent developers working on the same and different teams. Typical types of communication undertaken between developers includes asking each other for information related to the software as well as correlating shared goals, priorities, responsibilities, and schedules.

In many cases, a software developer must simultaneously obtain information and coordinate action to make progress on the software product. This type of communication is typically ad hoc, asynchronous, and intermittent. In other words, such communication does not occur at any regular intervals nor take a significant amount of time, but occurs often enough between sets of people that it serves a secondary purpose: creating and solidifying working relationships that continually improve the collective effectiveness of a group of people working on a software product. If communication between developers breaks down, dysfunctional relationships between developers can result, which may threaten the success of the software product.

A problem that can interfere with efficient communication between developers is the amount of effort that is often required to identify, from a large set of developers, the small subset of developers who are relevant to a particular developers' information and coordination needs. Currently there is no tool that enables a user of an integrated development environment tool to quickly identify (from the large set of developers), the small subset who are relevant to the user's information and coordination needs.

### SUMMARY

The following is a brief summary of subject matter that is described in greater detail herein. This summary is not intended to be limiting as to the scope of the claims.

Described herein are various technologies pertaining to the provision of information to a user of an integrated development environment tool. This information can include identities of developers (or other individuals) that are relevant to information and/or coordination needs of the user of the tool. An integrated development environment tool, in accordance with an exemplary embodiment, can be provided with functionality that allows a user thereof to quickly ascertain information pertaining to individuals that are somehow relevant to a current task of the user. As is known in the art, an integrated development environment tool is a software application that provides comprehensive facilities to computer programmers for software development. Accordingly, an integrated development environment tool can include a source code editor, a compiler and/or an interpreter, build automation tools, as well as a debugger.

A graphical user interface of an integrated development environment tool, in accordance with aspects described herein, can include a first pane that comprises a list of selectable file names. Each file name can identify a respective file that is a portion of a software product that is being developed by a user of the tool in coordination with several developers. For large scale software products, numerous (hundreds or even thousands) of developers may simultaneously work in conjunction to generate a software product. Individual files that make up the software product, however, are typically accessed by a relatively small number of developers (e.g. 1-10 developers). Responsive to the user of the integrated development environment tool selecting one of the selectable file names in the first pane, a second pane in the graphical user interface of the tool can be populated with editable code of the file represented by the selected file name. The second pane can facilitate text editing, such that the user can edit source code that is displayed in the second pane.

Additionally, responsive to the user selecting the file name in the first pane, graphical data that identifies individuals (e.g., developers) that have previously modified the file is presented to the developer. In an exemplary embodiment, the graphical data can be images of faces of developers that have previously modified the file. In another exemplary embodiment, the graphical data may be avatars that identify developers that have previously modified the file. In still yet another exemplary embodiment, the graphical data may be at least a portion of a name or e-mail alias of developers that have previously modified the file.

Additionally, the graphical data presented to the developer responsive to receipt of the selection of the file name can be formatted to be informative as to communication statuses of the developers that have previously modified the file. For example, the communication status of a particular developer can be currently available, in a meeting, idle for some period of time, offline, or the like. Such communication status can be extracted from, for example, an instant messaging application, an e-mail application, a calendar, an operating system of the computer of the developer, and/or other application. Therefore, if the user of the integrated development environment tool wishes to communicate with a particular developer identified by the graphical data, the user of the tool can quickly ascertain the availability of such developer. The graphical data that identifies a developer may include a color bar that is shaded in a certain color, such as red, to indicate that the developer is currently busy or in a meeting. Similarly, the graphical data may include a color bar that is shaded yellow to indicate that the developer is currently idle and has not actively used her computer for some threshold amount of time. In another example, the graphical data may include a color bar that is shaded green to indicate that the developer is currently available.

In many cases the user of the integrated development environment tool may wish to obtain further information about a particular developer identified in the graphical data presented to such user. The user of the tool can select graphical data that identifies a particular developer. Selection can be undertaken, for instance, by hovering a cursor over the graphical data that identifies the developer (an image of the face of the developer). In another embodiment, the user of the tool can position a cursor over the graphical data and click a button a mouse to select the graphical data. In yet another embodiment, the user can issue a voice command to select the graphical data, may press a touch sensitive screen a location on the screen corresponding to the graphical data, etc. Responsive to the user of the tool selecting the graphical data that identifies the particular developer, biographical information pertaining to such developer can be presented to the user of the tool in a pop-up window or pane (e.g., as a tooltip). Pursuant to an example, the biographical information can includes an image of the face of the developer, a name of the developer, an e-mail alias of the developer, a current communication status of the developer (busy, away, available), a job title of the developer, details pertaining to the job title of the developer, an identity of a supervisor and/or subordinate of the developer, a physical location of the developer (absolute location or location relative to the location of the user of the tool), as well as historic file interaction data. The historic file interaction data can indicate a number of total modifications that have been made to the file by the developer (12 of 46 check-ins of this file were made by the developer), a date that identifies a most recent check-in made by the developer, a date that identifies a first check-in made by the developer, and other information pertaining to historic interaction with the file by the developer.

The window (tooltip) displayed to the user of the tool responsive to the user selecting graphical data that identifies the particular developer may also include a plurality of selectable buttons that correspond to a plurality of communications applications. For example, the tooltip can include a first button that corresponds to an e-mail application, such that if the user of the tool selects the first button the e-mail application is automatically caused to prepare a new e-mail for transmittal to the developer from the user, and the subject line can be automatically populated with, for instance, data that identifies the selected file. A second selectable button can correspond to an instant messaging/chat application, such that if the user of the tool selects the second selectable button, the instant messaging/chat application generates a conversation window that is directed towards the developer. In yet another example, a third selectable button can correspond to a voice communications application, such that if the user of the tool selects the third selectable button the voice communications application is automatically initiated and a voice call is automatically placed to the identified developer (e.g. a VoIP call). It can therefore be ascertained that the integrated development environment tool can be configured to provide the user of such tool with data and tools that facilitate communication between the user and one or more other developers that are relevant to the current task of the user.

Other aspects will be appreciated upon reading and understanding the attached figures and description.

### BRIEF DESCRIPTION OF THE DRAWINGS

FIG. 1 is an exemplary graphical user interface of an integrated development environment tool.

FIG. 2 is an exemplary graphical user interface of an integrated development environment tool.

FIG. 3 is a functional block diagram of an exemplary system that facilitates providing data to a user of an integrated development environment tool that is relevant to a current task of the user.

FIG. 4 is a flow diagram that illustrates an exemplary methodology for providing graphical data pertinent to a task of a user of an integrated development environment tool.

FIG. 5 is an exemplary computing system.

### DETAILED DESCRIPTION

Various technologies pertaining to provision of graphical data to a user of an integrated development environment tool will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

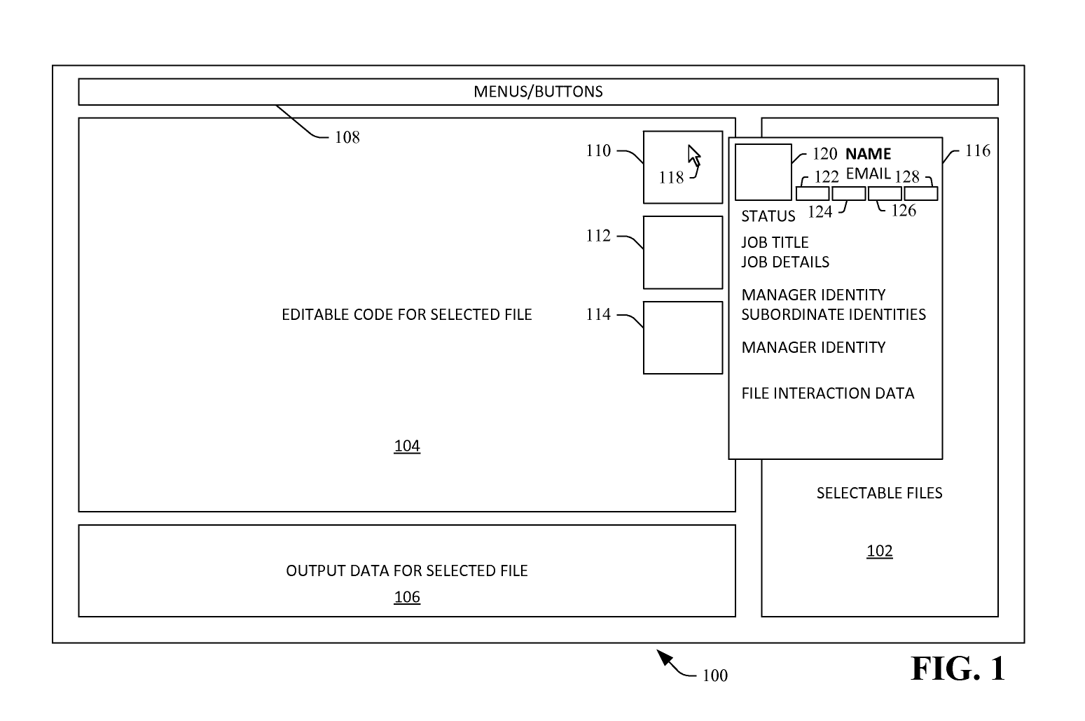

With reference now to FIG. 1, an exemplary graphical user interface 100 for an integrated development environment tool is illustrated. Integrated development environment tools are software-based tools that provide comprehensive facilities to computer programmers for software development. An integrated development environment tool typically includes a source code editor, a compiler and/or an interpreter, build automation tools, and a debugger. Integrated development environment tools are employed by software developers to generate software products. In many cases, creating a single software product requires the skills of several (hundreds or thousands) of software developers on different teams that operate on different files, oftentimes across relatively large geographic distances. The graphical user interface 100 provides information to a user of an integrated development environment tool that allows the user to quickly ascertain which developers are pertinent to the current task of the user.

The graphical user interface 100 includes a first pane 102 that displays a list of selectable file names to a user of the integrated development environment tool. Each file name included in the 1st pane 102 represents a respective file, wherein each file comprises source code. The source code in the files may be any suitable programming language that is supported by the integrated development environment tool. Exemplary languages include C, C#, and the like.

The graphical user interface 100 additionally comprises a second pane 104, wherein the second pane 104 is populated with source code of a file corresponding to a file name selected by the user of the tool in the first pane 102. In other words, responsive to the user selecting a selectable file name in the first pane 102, the second pane 104 is populated with source code of the file identified by the selected file name. The second pane 104 can operate as a text editor, such that source code presented in the second pane 104 can be modified by the user of the integrated development environment tool.

The graphical user interface 100 further comprises a third pane 106 that can display output data pertaining to a selected file. For instance, the integrated development environment tool can include a compiler and/or debugger, and the third pane 106 can present the user of the tool with data output by the compiler and/or debugger. The graphical user interface 100 may further comprise a menu/button bar 108 that includes a plurality of selectable menus and/or buttons that are associated with operations that can be undertaken on software being developed by way of the tool.

The graphical user interface 100 further comprises a plurality of images 110-114 that respectively identify a plurality of developers that have previously modified (checked in) the file (displayed in the second pain 104) that is identified by the file name selected by the user of the tool in the 1st pane 102. While the exemplary graphical user interface 100 is shown as including the three images 110-114, it is to be understood that the number of images displayed in the graphical user interface 100 will correspond to (will be equal to) the number of developers that have previously modified the file selected by the user. The plurality of images 110-114 can be presented to the user of the tool responsive to the user of the tool selecting a file name in the first pane 102. Further, the images 110-114 identify only developers that have previously modified the file selected by the user of the tool. Therefore, other individuals that have no knowledge of contents of the file (such as potentially other team members of the user of the tool) are not identified in the images 110-114.

In an exemplary embodiment, the images 110-114 may be images of faces of developers that have previously modified the selected file. Accordingly, the user of the tool can quickly ascertain whether she has ever met with or otherwise recognizes the developers who have previously modified the selected file. In another exemplary embodiment, the images 110-114 and may be avatars that identify respective developers that have previously modified the selected file. In still yet another exemplary embodiment, rather than displaying images in the graphical user interface 100, other data that uniquely identifies developers that have previously modified the selected file can be presented to the user of the tool, such as but not limited to names of such individuals, e-mail aliases of such individuals, instant messaging aliases of such individuals, etc.

Furthermore, in an exemplary embodiment, graphical indicia can be assigned to each of the images 110-114 to indicate to the user of the tool the availability of the individuals identified in the images 110-114. Pursuant to an example, at least a portion of a border of the images can be color-coded to indicate availability of individuals represented by the images 110-114. For instance, a color of gray can indicate to the user of the tool that the individual represented by a particular image is off-line. Similarly, a color of red can indicate that a user is busy or in a meeting, the color of yellow indicate that a developer is idle or has not used their computer for some threshold amount of time (10 min.), and a color of green can indicate that the developer identified by the image is currently available. Therefore, the user of the tool can quickly ascertain which developers have previously modified the selected file and the current availability of such developers.

Further, the images 110-114 may be arranged in an order or graphically depicted to indicate which developers have most recently modified the file selected by the user of the tool and/or which developers have most often modified the file selected by the user of the tool. For instance, the first image 110 can identify the developer that has most recently modified the file (other than the user of the tool) while the third image 114 can identify the developer that least recently modified the file. In another exemplary embodiment, the first image 110 can represent a developer that has most often modified the file while the third image 114 can represent a developer that has least often modified the file. In other embodiments, sizes of the images 110-114 can be indicative of historic modifications to the selected file, such that a largest image identifies a developer that has most often modified the file while a smallest image identifies a developer that has least often modified the file.

The graphical user interface 100 further comprises a window 116 that is presented to the user of the tool responsive to the user of the tool selecting one of the images 110-114 that identifies a certain developer. The user can select an image through utilization of a cursor 118. In an example, the user can hover the cursor 118 over one of the images 110-114 to select such image. In the example shown in FIG. 1, the cursor 118 is hovered over the first image 110. In other embodiments, the user can select an image through left clicking a mouse, right clicking a mouse, utterance of a voice command, by pressing a location on a touch sensitive screen that corresponds to the image, etc.

The window 116 is populated with additional data pertaining to the developer identified by the selected image and/or historic interaction of the developer with respect to the selected file. In an example, the window 116 can comprise an image 120 that identifies the selected developer. For instance, the image 120 can be identical to the image 110, thereby informing the user of the tool that such user has selected the developer corresponding to the image 110. The window 116 can further include a name of the developer identified by the selected image and an e-mail alias of the developer identified by the selected image.

The window 116 can additionally comprise data that indicates the status of the selected developer, wherein the status is indicative of the current availability of such developer. For instance, the status may be based upon calendar entries of the developer, a status of an instant messaging application, or the like. For example, the status can indicate that the selected developer is currently available, is in a meeting, as away, or is offline.

The window 116 can further include additional details pertaining to the developer, such as the job title of the developer as well as additional developer-related details. The developer-related details, for instance, can identify a team of the developer, a department of the developer, or the like. The window 116 can further comprise identities of a supervisor or subordinate of the developer. For example, oftentimes in relatively large companies, the user of the tool may not recognize the developer but may recognize a manager of the developer. Alternatively, the user of the tool may not recognize the developer but may recognize subordinates of the developer. Accordingly, such data can be presented to the user in the window 116.

The window 116 can also comprise data that is indicative of the geographic location of the developer identified by the selected image. The location can be an absolute location, such as an address, an office number, or the like. In another example, the location may be a location relative to a current location of the user of the tool, such that directions are provided to the user of the tool (e.g., this person is located on your floor).

Furthermore, the window 116 can display data that is indicative of historic interaction of the developer with respect to the selected file. This historic interaction data can include a number of total modifications to the file that were made by the selected developer, an indication of whether or not the selected developer made the most recent modification to the file, a date that indicates when the developer made a most recent modification to the file, a date that indicates when the developer made her first modification to the file, amongst other historic file interaction data pertaining to the selected developer.

The window 116 may further comprise a plurality of selectable buttons 122-128. The selectable buttons may correspond to communications applications that can be employed by the user of the tool to communicate with the selected developer. In an example, the first selectable button 122 may correspond to an e-mail application, such that if the user selects the first selectable button 122 (e.g. through utilization of a cursor) an e-mail application will be initiated and/or the e-mail application is caused to generate new e-mail for transmittal to the selected developer (the e-mail is populated with the e-mail alias of the selected developer). Additionally or alternatively, the subject line of the new e-mail can be automatically populated with data pertaining to the file, such as but not limited to the current file path, class, and method (if applicable).

The second selectable button 124 can represent a chat/instant messaging application, wherein if the user of the tool selects the second selectable button 124 an instant messaging/chat session is automatically initiated with the developer identified by the selected image. In other words, an instant messaging/chat conversation window can be automatically provided to the user of the tool, wherein such conversation window is configured for transmittal to the developer identified by the selected image.

The third selectable button 126 may represent, for instance, a voice communications application such as a voice over Internet protocol (VoIP) communications application that facilitates establishing a voice communication connection between a computer of the user of the tool and a computer of the developer identified by the selected image. Selection of the third selectable button 126 can result in the initiation/automatic placement of a voice call to the developer identified by the selected image.

The fourth selectable button 128 can represent a screen sharing application, such that selection of the fourth selectable button causes the screens haring application to be initiated. The screen sharing application can provide the developer identified by the selected image with a view of the screen of the user of the tool. The developer can then review editable code included in the second pane 104, and can provide suggestions/commentary to the user of the tool.

In the exemplary embodiments described herein, the selectable buttons 122-128 cause other communication applications to be initiated/employed to facilitate communications between the user of the tool and the developer identified by the selected image. In other exemplary embodiments, the functionality corresponding to the aforementioned applications can be embedded in the integrated development environment tool itself. Other communications functionality that can be initiated or represented by selectable buttons in the window 116 are also contemplated and intended to fall under the scope of the hereto appended claims. For example, videoconferencing applications, programming sharing applications, or other suitable communications applications are contemplated.

While the window 116 has been described as depicting the image 120, the selectable buttons 122-128, and details pertaining to the communication status, job title, job details etc. of the developer identified by the selected image, it is to be understood that in other embodiments other data can be presented to the user of the tool. For example, the window 116 can include data that describes how the developer identified by the selected image previously modified the file. For instance, the window 116 can inform the user of the tool that the developer identified by the selected image modified a particular line in the code shown in the second pane 104, as well as depict exactly what modification was made by the developer.

In another exemplary embodiment, the window 116 can present an organizational hierarchy chart to the user of the tool, such that the user of the tool can visually ascertain where the selected developer resides in an organizational hierarchy. Thus, the user of the tool can quickly ascertain the identity of an immediate supervisor of the developer, subordinates of the developer, team of the developer, other managers upwards in the organizational hierarchy, etc.

Still further, the window 116 can present data to the user of the tool that indicates to such user when the last communication was undertaken between the user of the tool and the selected developer. For instance, the window 116 can inform the user of the tool that such user had an instant messaging conversation with the developer identified in the selected image three days ago. Additionally, the window 116 can inform the user of the tool that the developer sent an e-mail to the user a certain time ago, and can include a link to such e-mail. Thus, the user of the tool can quickly ascertain context of a most recent conversation between the user of the tool and the developer.

In another exemplary embodiment, the window 116 can depict historical information to the user of the tool that identifies data pertaining to the developer at the time that the developer made modifications to the selected file. In an example, the selected developer may not have worked on such file for a relatively long period of time (several years), and the position of the developer in a software development company may have changed over that time. Accordingly, it may be helpful to the user of the tool to have knowledge of the position of the developer in the company at the time that a most recent modification to the file was made by such developer, including identities of supervisors of the developer at such time, identities of subordinates of the developer at such time etc. Again, this can provide additional context as to the status of the selected file.

Further, the images 110-114 have been described as identifying developers that have previously modified the code. In other exemplary embodiments, the images may identify other people that pertain to the file selected by the user. For instance, the user of the tool may wish to be provided with images that identify testers of code in the file. For instance, the user of the tool may wish to discuss testing timelines with a particular tester, particularly if the user of the tool plans to make a relatively major modification to the file. This can allow a selected tester to use her time in more productive manners than testing a file that is going to be subject to a major modification. In another example, the user of the tool may wish to be provided with images that identify developers of code that is dependent upon a selected file. In such case, the images 110-114 can identify developers/testers of code that is dependent upon the selected file. Similarly, the images 110-114 may include an image of a liaison. For instance, a group of individuals may be cooperatively working on one or more files, wherein individuals in the group are geographically dispersed by a large distance (e.g., reside on different continents). Accordingly, a user of the tool may have working hours that are non-overlapping with working hours of a developer that also modifies the selected file. Often, a company will have a liaison that acts as an intermediary between developers across different time zones. Therefore, the images 110-114 may include an image that identifies a liaison that can be contacted to answer questions pertaining to the selected file.

Other integrated buttons may also be provided to allow the user of the tool to communicate with multiple individual simultaneously. For instance, a button can be positioned above the images 110-114, where selection of such button causes an e-mail application to generate a new e-mail that is to be directed to each developer identified by the images 110-114. Additionally or alternatively, such button can initiate a group instant messaging conversation, where an instant message is directed to each of the developers identified in the images 110-114.

Further, graphical indicia can be assigned to the images 110-114 to inform to the user of the tool of the organizational placement of the developers identified by the images 110-114. For instance, color or text can be assigned to at least portions of the images 110-114 to inform the user of the tool of which developers or on a same team, can inform the user of the identity of a team that includes certain developers, etc.

Moreover, the images 110-114 can be highlighted as the user of the tool moves the cursor over particular lines in the code shown in the second pane 104. For instance, the user of the tool may hover the cursor 118 over a particular line in the code in the second pane 104. Responsive to the user hovering the cursor 118 over a particular line, one or more of the images 110-114 can be highlighted to inform the user of the tool of which of the developers identified in the images 110-114 modified that particular line in the code. Thus, the user of the tool can quickly ascertain which of the developers identifies in the images 110-114 modified which of the lines of code displayed in the second pain 104.

While the windows, panes, buttons, and the like have been shown as being in particular positions in the graphical user interface 100, it is to be understood that positions of such windows, panes, buttons, etc. can vary and still fall under the scope of the hereto-appended claims. For example, the images 110-114 may be shown in a border on the bottom of the graphical user interface 100, and a window depicting additional data pertaining to a selected developer may be shown on the left hand side of the second pane 104. Other arrangements are also contemplated.

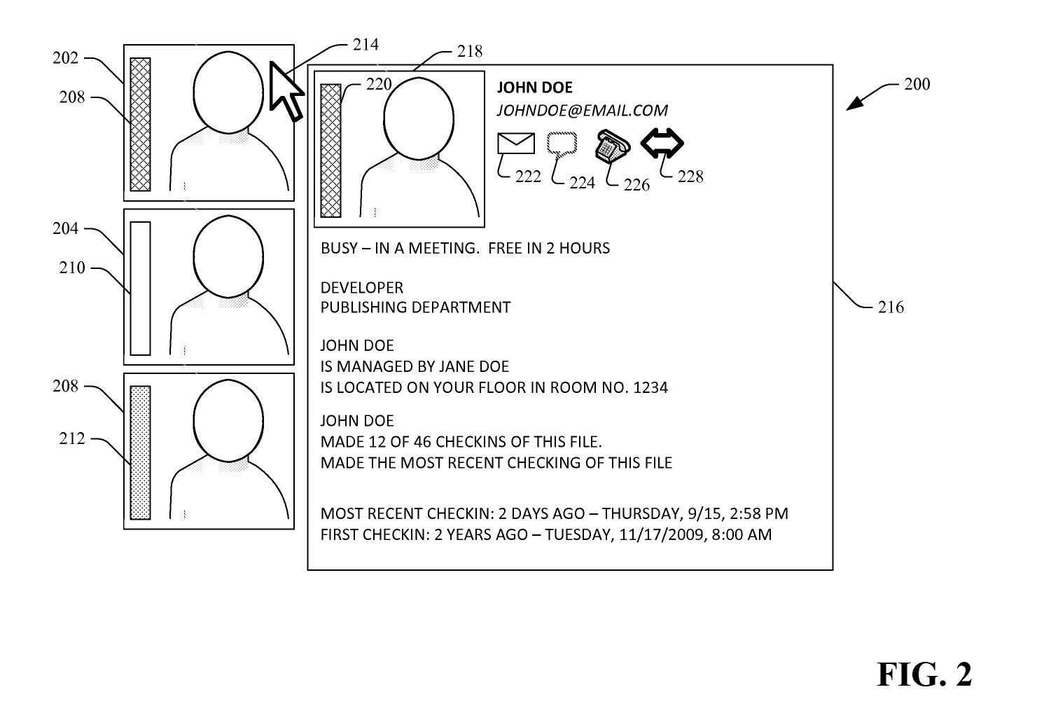

With reference now to FIG. 2, another exemplary graphical user interface 200 is depicted. The graphical user interface 200 is a portion of a graphical user interface of an integrated development environment tool. The graphical user interface 200 comprises a plurality of images 202-206 that are presented on a display screen of a computing device responsive to a user of an integrated development environment tool selecting a selectable file name in the first pane 102. For example, as described above, the images 202-206 identify developers that have previously modified the selected file. In the graphical user interface 200, the images 202-206 are shown to be faces of developers/testers/liaisons that are in some way relevant to the user of the tool and/or the selected file. Each of the images 202-206 has a respective color bar 208-212 therein, wherein the color bars 208-212 identify the communication status of the developers identified by the images 202-206 to the user of the tool.

The user of the tool can select the image 202 by placing a cursor 214 over such image 202 and hovering the cursor 214 over the image 202. Hovering the cursor 214 over the image 202 causes a window 216 to be presented to the user of the tool.

The window 216 includes an image 218 with a color bar 220, wherein the image 218 is identical to the selected image 202 (the image being hovered over by the cursor 214). This informs the user of the tool of which of the images has been selected by the user. As described above, the window 216 can include the name of the developer, the e-mail address of the developer, the communications status of the developer, the position in the company of the developer, a department of the developer, a manager of the developer, a location of the developer, a number of check-ins made by the developer to the selected file, data that indicates that the developer made the most recent check-in of such file, data pertaining to when the developer most recently checked in the file, data that indicates when the file was first checked in (when the file was added to the data repository), data that indicates when the developer made the most checkins of the file, data pertaining to when the developer first checked-in the file, etc. Additionally, the window 216 can include a plurality of selectable buttons 222-228. Selection of one of the selectable buttons causes a respective corresponding communications application to be initiated to facilitate communications between the user of the tool and the individual represented by the selected image. As shown, selection of the first button 222 can initiate an e-mail application, selection of the second button 224 can initiate an instant messaging application, selection of the third button 226 can initiate a voice communications application, and selection of the fourth button 228 can initiate a screen sharing application.

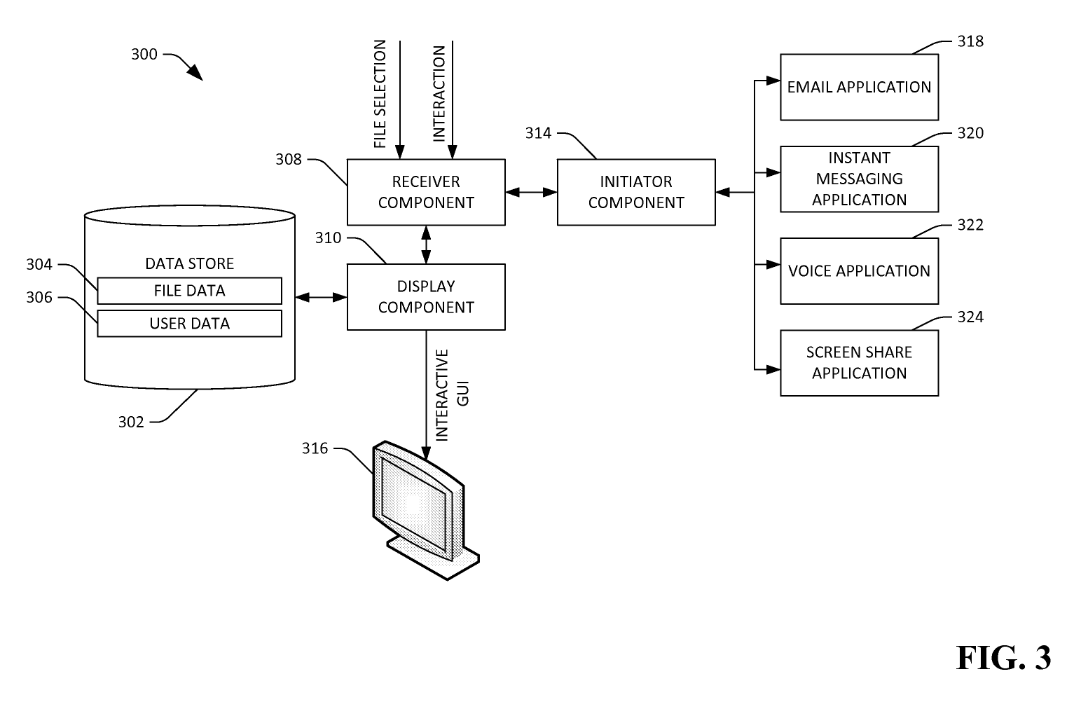

With reference now to FIG. 3, an exemplary system 300 that facilitates provision of data pertaining to a file selected by way of an integrated development environment tool is illustrated. The system 300 comprises a data store 302 that includes file data 304 as well as user data 306. The file data 304 comprises a plurality of file names and corresponding file contents, as well as file modification history data. File modification history data can include times when files were modified, identities of individuals that modified the files, etc. The user data 306 can include biographical data pertaining to individuals that have modified files included in the file data 304. As described above, this biographical data can include images that identify individuals that have modified files, e-mail aliases of individuals that have modified files in the file data 304, instant messaging aliases of such individuals, geographic locations of such individuals, organizational position of the individuals, amongst other biographical data.

The system 300 further comprises a receiver component 308, a display component 310, and an initiator component 314. For instance, these compounds 308-314 may be included in an integrated development environment tool. The receiver component 308 receives a selection of a file name displayed in the first pane 102 of the graphical user interface 100 for the integrated development environment tool. The filename is representative of a file that comprises code that is editable by way of the tool. The display component 310 is in communication with the receiver component 308 and accesses the data store 302 responsive to the receiver component 308 receiving the selection of the file name. As described above, the display component 310 can cause at least a portion of the biographical data of individuals in the user data 306 that have previously modified the selected file to be displayed on a display screen 316 of a computing device. Additionally, the display component 310 can cause at least a portion of the editable code of the file to be displayed on the display screen 316 in the graphical user interface of the integrated development environment tool.

Further, the receiver component 308 can receive a selection of an image that identifies an individual that has previously modified the file, and the display component 310 can cause additional biographical data to be displayed on the display screen 316 of the computing device. Specifically, the display component 310 can cause a plurality of selectable buttons corresponding to different communications applications to be displayed on the display screen 316 responsive to the receiver component 308 receiving a user selection of a particular image. Similarly, the display component 310 can display location of the user and other biographical data in the user data 306 on the display screen 316 responsive to the receiver component 308 receiving a selection from the user of the tool of an image presented to such user.

As described above, the display component 310 can cause a plurality of selectable buttons to be displayed corresponding to different communications applications. The receiver component 308 can receive a user interaction with respect to one of such buttons and can initiate a particular application corresponding to the selected button to allow the user of the tool to communicate with the individual identified by the selected image. Pursuant to an example, the initiator component 312 can initiate one of an e-mail application 318, an instant messaging application 320, a voice application 322, or a screen share application 324. Other communications applications are also contemplated and are intended to fall under the scope of the hereto appended claims.

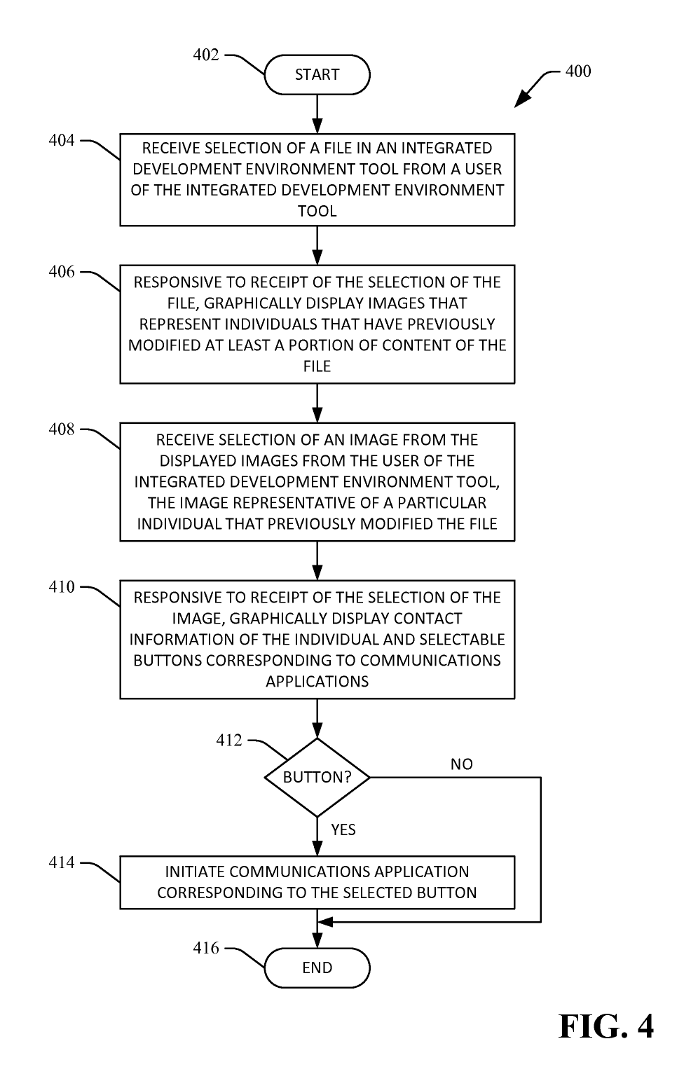

With reference now to FIG. 4, an exemplary methodology is illustrated and described. While the methodology is described as being a series of acts that are performed in a sequence, it is to be understood that the methodology is not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodology may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

Now referring to FIG. 4, an exemplary methodology 400 that facilitates provision of relevant data to a developer of a software product is illustrated. The methodology 400 starts at 402, and at 404 a selection of a file in an integrated development environment tool is received from the user of such tool.

At 406, responsive to receipt of the selection of the file, images are graphically displayed that represent individuals that have previously modified at least a portion of content of the selected file. Further, editable code of the file is displayed simultaneously with the images. Accordingly, responsive to the user of the tool selecting a certain file, images of individuals that have performed some action that is relevant to the current task of the user of the tool are graphically presented to the user.

At 408, a selection of an image from the displayed images is received from the user of the tool. As noted above, the image is representative of a particular individual that previously modified the file.

At 410, responsive to receipt of the selection of the image, contact information of the individual is displayed to the user of the tool, as well as a plurality of selectable buttons corresponding to communications applications that can be employed by the user of the tool to communicate with the individual identified by the selected image. Additionally, responsive to receipt of the selection of the image, biographical data pertaining to the individual that has previously modified the code is presented to the user of the tool.

At 412, a determination is made regarding whether the user of the tool has selected one of the selectable buttons corresponding to a communications application. If it is determined at 412 that a particular button has been selected, then at 414 a corresponding communications application is initiated to facilitate a desired form of communications between the user of the tool and the individual. If it is determined at 412 that no button has been selected, then the methodology 400 completes at 416.

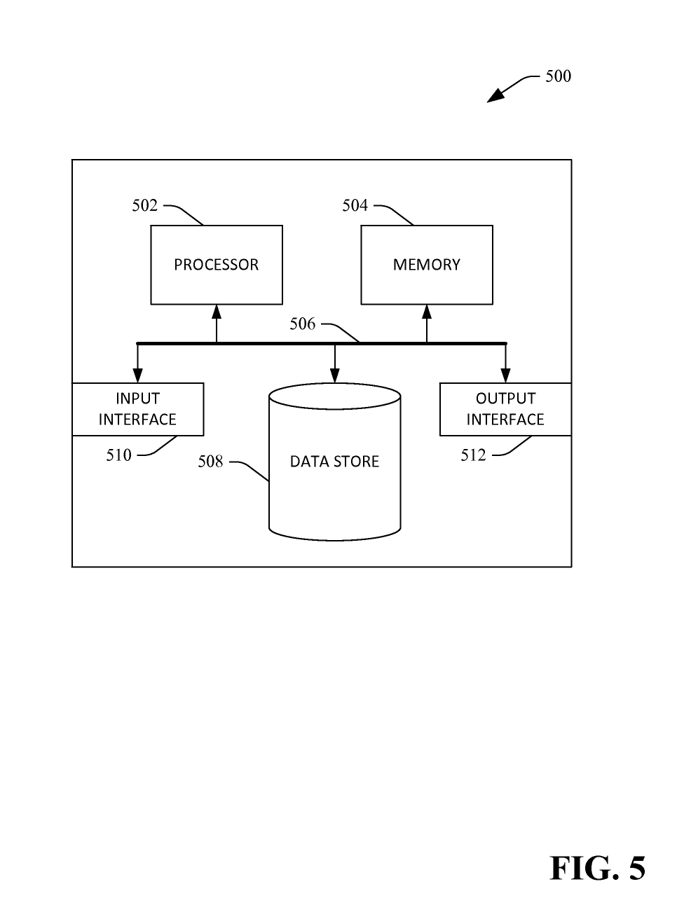

Now referring to FIG. 5, a high-level illustration of an exemplary computing device 500 that can be used in accordance with the systems and methodologies disclosed herein is illustrated. For instance, the computing device 500 may be used in a system that supports provision of graphical data to a software developer. The computing device 500 includes at least one processor 502 that executes instructions that are stored in a memory 504. The memory 504 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 502 may access the memory 504 by way of a system bus 506. In addition to storing executable instructions, the memory 504 may also store file history data, developer biographical data, etc.

The computing device 500 additionally includes a data store 508 that is accessible by the processor 502 by way of the system bus 506. The data store may be or include any suitable computer-readable storage, including a hard disk, memory, etc. The data store 508 may include executable instructions, file history data, biographical developer data, etc. The computing device 500 also includes an input interface 510 that allows external devices to communicate with the computing device 500. For instance, the input interface 510 may be used to receive instructions from an external computer device, a user, etc. The computing device 500 also includes an output interface 512 that interfaces the computing device 500 with one or more external devices. For example, the computing device 500 may display text, images, etc. by way of the output interface 512.

Additionally, while illustrated as a single system, it is to be understood that the computing device 500 may be a distributed system. Thus, for instance, several devices may be in communication by way of a network connection and may collectively perform tasks described as being performed by the computing device 500.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A computer-readable medium comprising instructions that, when executed by a processor, cause the processor to perform acts comprising:
displaying a graphical user interface for an integrated development environment tool on a display screen of a computing device, the graphical user interface comprising:
a first pane that includes at least one selectable file name that represents a file, the file includes code editable by way of the integrated development environment tool; and
a second pane;
receiving a selection of the at least one selectable file name in the first pane;
responsive to receiving the selection of the at least one selectable file name in the first pane:
populating the second pane with content of the file; and
displaying a plurality of images that represent individuals that have previously modified the file on the display screen of the computing device;
receiving a selection from the user of an image in the plurality of images, the image representing a particular individual that previously modified the file; and
responsive to receiving the selection from the user of the image in the plurality of images, displaying data that indicates when the particular individual most recently modified the file.

2. A method, comprising:
in an integrated development environment tool, receiving a selection of a file from a user of the integrated development environment tool, the file desirably modified by the user of the integrated development environment tool; and
responsive to receiving the selection of the file from the user, graphically presenting to the user on a display screen of a computing device:
source code included in the file; and
a plurality of images that are representative of a corresponding plurality of individuals that have previously modified the file, the plurality of images selectively arranged to identify which of the plurality of individuals most recently modified the file.

3. The method of claim 2, wherein the plurality of images are images of faces of the corresponding plurality of individuals.

4. The method of claim 2, wherein the plurality of images each have graphical indicia thereon that is indicative of current availability of the respective plurality of individuals.

5. The method of claim 2, wherein the plurality of images are selectively arranged such that an image corresponding to an individual that most recently modified the file is displayed above all other images that identify the individuals that have previously modified the file.

6. The method of claim 2, further comprising:
receiving a selection of an image from amongst the plurality of images from the user; and
responsive to receiving the selection of the image, displaying additional data pertaining to the individual that is identified by the image to the user.

7. The method of claim 6, wherein the selection of the image is a hover of a cursor over the image.

8. The method of claim 6, wherein the additional data pertaining to the individual comprises:
data that indicates to the user of the integrated development environment tool when the individual last modified the file.

9. The method of claim 8, wherein the additional data pertaining to the individual further comprises:
data that indicates to the user of the integrated development environment tool when the individual first modified the file; and
a number of modifications of the file that are attributed to the individual.

10. The method of claim 8, wherein the additional data pertaining to the individual further comprises:
an identity of a supervisor of the individual; and
an email alias of the individual.

11. The method of claim 8, wherein the additional data pertaining to the individual further comprises:
a plurality of selectable buttons that are representative of communications applications employed by the individual, the method further comprising:
receiving a selection of a selectable button in the plurality of selectable buttons; and
responsive to receiving the selection of the selectable button, initiating a communications application that is represented by the selectable button.

12. The method of claim 11, the communications application being one of an email application, an instant messaging application, a voice communication application, or a screen share application.

13. The method of claim 12, the communications application being the email application, and further comprising:
automatically providing the email application with an email address of the individual; and
automatically providing the email application with detail pertaining to the file such that a subject field of an email directed to the individual is automatically populated with the detail pertaining to the file.

14. A system that facilitates graphical provision of data pertaining to historic modification of a file, the system comprising:
a receiver component receives a selection of a file name displayed in a first pane of a graphical user interface of an integrated development environment tool, the file name representative of a file that comprises source code;
a display component that accesses a data repository responsive to the receiver component receiving the selection of the file name, the data repository comprising:
file history data that identifies individuals that have previously modified the file that comprises the source code; and
biographical data that is assigned to each of the individuals identified in the file history data;
wherein the display component causes at least a portion of the biographical data assigned to individuals in the file history data that have previously modified the file to be displayed on a display screen of a computing device together with at least a portion of the source code in the graphical user interface of the integrated development environment tool.

15. The system of claim 14, wherein the at least the portion of the biographical data that is displayed on the display screen of the computing device are images of the individuals that have previously modified the file.

16. The system of claim 15, wherein the display component displays the images in an order to identify which of the individuals most recently modified the file.

17. The system of claim 15, wherein the receiver component receives a selection of an image assigned to an individual that has previously modified the file, and wherein the display component causes the biographical data assigned to the individual that has previously modified the file to be displayed in a pane in the graphical user interface of the integrated development environment tool.

18. The system of claim 17, wherein the biographical data assigned to the individual that has previously modified the file comprises data that indicates to a user of the integrated development tool when the individual that has previously modified the file has most recently modified the file.

19. The system of claim 17, wherein the biographical data assigned to the individual that has previously modified the file comprises data that identifies to a user of the integrated development environment tool a supervisor of the individual that has previously modified the file.

20. The system of claim 15, wherein the display component further causes a plurality of selectable buttons to be included in the pane in the graphical user interface of the integrated development environment tool, wherein the plurality of selectable buttons correspond to a plurality of communications applications that facilitate communications between the individual that previously modified the file and a user of the integrated development environment tool, wherein the receiver component receives a selection of a selectable button from amongst the plurality of selectable buttons, and the system further comprising an initiator component that automatically initiates a communications application that corresponds to the button selected by the user of the integrated development environment tool responsive to the receiver component receiving the selection of the selectable button.
